(19) United States
(12) Patent Application Publication
(10) Pub. No.: US 2025/0026054 A1
(43) Pub. Date: Jan. 23, 2025

(54) SELF-RELEASING TIE

(71) Applicant: Rapstrap Ltd, Hertford, Hertfordshire (GB)

(72) Inventor: Andrew Harsley, Hertford, Hertfordshire (GB)

(21) Appl. No.: 18/714,441

(22) PCT Filed: Nov. 30, 2022
(86) PCT No.: PCT/GB2022/053036

§ 371 Date: May 29, 2024

(30) Foreign Application Priority Data
Nov. 30, 2021 (GB) 2117273.9

(51) Int. Cl. B29C 45/00; B29C 45/27; B29K 67/00; B29L 31/00

(52) U.S. Cl. CPC B29C 45/0046; B29C 45/2708; B29K 2067/00; B29K 2995/005; B29L 2031/7276

(57) ABSTRACT

A method of making a tie strip from as stretch-orientable thermoplastic comprising a series of joined unit cells, wherein the moulding material is injected into the mould at multiple gating points along the strip to introduce flow discontinuities thereby to localise regions for stretch orientation.

### TECHNICAL FIELD OF INVENTION

The present invention relates to tie strips, as used for fastening cables, bags, plants, etc., and especially tie strips manufactured by injection moulding followed by stretch-orientation.

### BACKGROUND ART

Various stretch-oriented tie strips are proposed in the prior art, the most relevant being ladder-style ties, ties with head portions containing barbed-latches, and ties with ratchet-teeth. These are respectively exemplified by U.S. Pat. No. 3,766,608 (Fay, 1973), U.S. Pat. No. 3,996,646 (Caveney, 1976) and U.S. Pat. No. 4,473,524 (Paradis, 1984).

Preforms of such tie strips are said to be injection moulded, presumably using conventional multi-cavity techniques, such as taught by U.S. Pat. No. 4,620,958 (Wiechard, 1986, FIG. 4) and illustrated in US2006254031 (DeMik & Brownlee, 2006, FIG. 3) and GB2578324 (Harsley, 2020, FIG. 1).

Subsequently stretching the preforms to their final size confers various benefits, as mentioned frequently in the prior art. Principally, stretch-orientation aligns the polymer molecules to increase the tensile strength in the direction of stretch; it reduces the amount of material required to attain a given strength; and it allows the manufacture of long and thin items than would otherwise be difficult to mould. Prior to the technique being applied to tie strips, U.S. Pat. No. 3,380,122 (Kirk, 1968) and U.S. Pat. No. 3,444,597 (Bone, 1969) describe the production of garment tags by drawing out filaments of stretch-orientable polymers such as nylon, polypropylene and polyethylene. U.S. Pat. No. 3,447,207 (Danzer, 1969) discloses a packaging or bailing band with a zig-zag cross-section which is produced by extrusion and stretching. As seen in these examples, stretching is generally conducted in the direction of melt flow during manufacture, i.e., in the machine direction rather than the transverse direction. As is well known in the industry, moulded and extruded polymer products are generally stronger in the machine direction because the polymer molecules are semi-aligned by the flow. Stretching is therefore conducted to exploit this directionality wherever possible.

Stretching a tie strip preform may be conducted by means of a clamping jig as disclosed by U.S. Pat. No. 3,983,603 (Joyce, 1976, C03-L13&c). The apparatus is said to utilise 300-400 psi of pressure with the (nylon) strip being pre-heated to 400 F (+/−50 F). Several patents mention a stretching speed of approximately 1 inch per second. This same technique is seen in U.S. Pat. No. 4,001,898 (Caveney, 1977, C03-L57&c), U.S. Pat. No. 4,003,106 (Schumacher, 1977, C03-L57&c), U.S. Pat. No. 4,580,319 (Paradis, 1986, C07-L52), U.S. Pat. No. 4,754,529 (Paradis, 1988, C06-L01&c) and U.S. Pat. No. 5,146,654 (Caveney, 1992, C02-L59). U.S. Pat. No. 4,866,816 (Caveney, 1989, filed 1974) teaches the tie should be removed from the mould and stretched while the strap portion is still in a heated and pliable condition. Otherwise, a separate heating step is required (ibid. C08-L60). FIG. 39 of U.S. Pat. No. 4,866,816 illustrates an apparatus for separately heating the strap, potentially in just localised areas by use of a mask (ibid. C09-L18).

An alternative stretching method is taught by U.S. Pat. No. 3,237,255 (Stanton, 1966, C02-L69&c and C03-L58&c), wherein an extruded band is passed through sets of pinch rollers rotating at different speeds. This method is less suitable for stretching tie strips with a substantially projecting head portion, but could be utilised for continuous ladder style ties such as the self-latching versions taught by US2013014350 (Lie, 2013) and U.S. Ser. No. 10/407,226 (Harsley, 2019). Being generally flat, these ties can readily pass between fixed rollers.

It is widely recognised in the prior art that the moulding process of compact preforms has issues. U.S. Pat. No. 4,136,148 (Joyce, 1979, C01-L67&c), states that “the use of cross linked members to form the ladder portion of the strap requires care in moulding to properly fill the mould, and can also require special attention to the moulding materials in order to achieve a satisfactory end product.” Joyce addresses the issue by introducing webs between the transverse rungs of the strap. These are said to improve the moulding process and limit the occurrence of voids and other moulding defects (ibid. C02-L27&c).

U.S. Pat. No. 4,866,816 (Caveney, 1989, C06-L11) also notes that ladder tie strips incorporating such a web “will achieve an improved filling characteristic for the mould and avoid regions of possible failure.” The same technique is also taught by U.S. Pat. No. 5,685,048 (Benoit, 1997, C03-L08&c), which states, “The particular construction of tail 39 must be noted. Webbing 45 facilitates production of tie 11 with improved operating moulding and stretching characteristics. Because of webbing 45, the material inserted into the mould, which is advantageously accomplished by injection moulding, has an enlarged channel for flow of the material, as compared with the standard ladder structure. The result is that imperfections that often attend moulding, such as cold shuts, voids and nit marks are either eliminated or significantly reduced in extent.”

Subsequent U.S. Pat. No. 6,105,210 (Benoit, 1999, C05-L22) also points out how a plain band (designated 139) is easier to mould than one containing rungs and webs (designated strap 31). It is stated that, “Strap 131 can be moulded using conventional moulding techniques. As can be appreciated, the simplicity of the size and shape of elongated filament 139 considerably simplifies the process for moulding strap 131 compared to the process of moulding strap 31 of prior art tie 11.” A related improvement is taught by U.S. Pat. No. 4,347,648 (Dekkers, 1982, C02-L37) wherein a web at the tongue stiffens the tail for insertion and makes it easier to mould, thereby reducing mould defects such as voids.

In addition to webbing, the side rails of ladder-style cable ties are also found to be important for the moulding process. In U.S. Pat. No. 4,473,524 (Paradis, 1984, C03-L27), it is stated that the “side rails can be omitted from one or both sides of the strap.” However, in U.S. Pat. No. 4,754,529 (Paradis, 1988, C03-L38&c), Paradis says that: “Although the side rails can be omitted from one or both sides of the strap, the side rails serve an important function in moulding of guiding the molten plastic to suitable portions of the strap. This is particularly important where the finally stretched strap will have thin webbed sections between adjoining teeth.” Furthermore, the unstretched side rails are stated as being significantly wider than the unstretched tooth portion. “This increase in width is desirable to facilitate the filing of the mould. A significant problem that is encountered in moulding is the provision of a sufficiently large cavity to fill the entire mould. The enlarged unstretched side rails 34-1′ provide suitable channels for assuring the filling of the entire mould.” (ibid. C07-L50&c). Additionally, “the width of the side rails can be altered to accommodate the filling of any length of strap.” (ibid. C07-L64).

US2017166370 (Schuttler, 2017, p[0028]) also comments on improving flow: “The material inserted into the mould, which may be advantageously accomplished by injection moulding, has an enlarged channel for the flow of material, as compared with the standard ladder tie. The result is that imperfections that often hinder moulding, such as cold shuts, voids and nit marks are either eliminated or significantly reduced in extent.”

Although not a stretch-oriented design, US2010212117 (Haase, 2010, p[0031-0032]) draws attention to the poor flow characteristics of compostable and biodegradable materials. “ . . . thus, during injection moulding, the reduced flowability of compostable resins may require additional measures to ensure the mould fills quickly and completely before the liquid resin solidifies.” “Thus, depending on the particular biodegradable or compostable resin being used, the dimensions or structure of the tie may need to be altered and/or the mould or injection moulding process may need to be modified. For example, the mould may need to be heated to maintain the resin at a flowable temperature (but below a degradation temperature) as the resin is injected into the mould. Further, the mould may include more than one point of injection or injection pressures may be increased to ensure that the entire mould cavity is filled.”

After the moulding stage, an obvious consequence of stretching any tie strip is the corresponding increase in tooth spacing (tooth pitch). U.S. Pat. No. 5,146,654 (Caveney, 1992, C01-L21&c) discusses the issue in some depth. “The spacing of the teeth as moulded is very accurate. However, once a tie has been stretched, it is very difficult to maintain uniformity of the distance between the strap teeth as a result of tolerances in the manufacturing process.” “Additionally, the as-moulded profiles of the strap teeth will change during stretching.”

Caveney states that when commercial samples of U.S. Pat. No. 4,754,529 (Paradis, 1988) are placed “under loads approaching the rated load, the [pawl] teeth 22t-1 and 22t-2 as shown in FIG. 5C of the '529 patent, will disengage from the strap, leaving only tooth 22t-3 on the pawl engaged with the strap.” Consequently, “there is actually a point where the strap will undergo retrograde movement relative to the head . . . such that the fixed [pawl] tooth 23t skips to the next strap tooth and actually changes the tension applied around a bundle.” (ibid. C01-L42&c). This problem is due to the '529 pawl having multiple teeth, and these require a precise strap tooth pitch (post-stretching) to properly engage. U.S. Pat. No. 4,754,529 (Paradis, 1988, C05-L37&c) had already acknowledged such inconsistent tooth spacing along the strap, especially towards the head portion, and had attempted to compensate.

U.S. Pat. No. 5,146,654 (Caveney, 1992) then teaches a solution of moving some of the latching pawl teeth onto the walls of the head portion so that the tooth pitch is less critical. In addition, it is noteworthy that Caveney describes long cable ties, wherein a larger tooth pitch is less problematic since said pitch represents only a small fraction of the fitted diameter. Caveney states the as-moulded (preform) tie is approximately 13 inches long, and this increases to 34 inches after stretching. This is accompanied by the strap width decreasing about 40% from approximately ½ inch to 0.3 inches (12 mm to 8 mm). Caveney asserts, “Such a tie uses less than 65 percent of the material for a conventionally moulded cable tie of the same length yet has greater strength.” (ibid. C03-L42).

Notwithstanding the above, U.S. Pat. No. 3,996,646 (Caveney, 1976) had previously advanced a stretch-oriented tie with a metal barb in the head portion as an alternative solution. Such tooth-less (or ratchet-less) designs provide continuous sizing, and the same concept is revisited by U.S. Pat. No. 5,517,727 (Bernard & Brownlee, 1996, C03-L35&c).

U.S. Pat. No. 4,473,524 (Paradis, 1984, C04-L01) offers a different approach, suggesting that “The strap will stretch to a degree when wrapped around a bundle, and when the wrapping force is released, the stretched strap will retract.” I.e., the strap retains some elasticity, and so long as the amount of attainable strap elastication exceeds the tooth pitch, the strap can be pulled to the next tooth, thereby ensuring a tight binding. Semi-elasticated ladder ties are further detailed by U.S. Pat. No. 7,704,587 (Harsley, 2010) and U.S. Ser. No. 10/407,226 (Harsley, 2019).

Finally, U.S. Pat. No. 4,573,242 (Lankton & Paradis, 1986, C01-L36) teaches that the presence of a central reinforcing rail permits the use of smaller diameter rungs, and this results in a closer spacing after stretching, hence more precise latching (ibid. C06-L03). U.S. Pat. No. 4,788,751 (Shely, 1987, FIG. 8) teaches a similar approach but with two rows of offset teeth. This effectively halves the tooth pitch to provide for finer adjustability, albeit at the expensive of doubling the width of tie strip required. Although this patent does not comment on using a stretch-orientable material, a person skilled in the art could clearly make such an adaptation.

As well as a change in tooth pitch, U.S. Pat. No. 4,001,898 (Caveney, 1977, C01-L42) also notes that because the “teeth formed on the strap at the time of moulding tend to become distorted or “smear” during stretching, it is difficult for a prior art integral locking means to effectively engage such a stretched strap.” U.S. Pat. No. 5,146,654 (Caveney, 1992, C03-L34) later comments that “While the [as-] moulded teeth 14 in FIG. 2 have a substantially trapezoidal configuration, once the strap is stretched the strap threading surface 3 and strap locking surface 38 become somewhat arcuate.” (Although not explained in said patents, this smearing is caused by the stretched portions of the strip drawing material out of neighbouring regions.) U.S. Pat. No. 4,136,148 (Joyce, 1979, C04-L22, and see the figures) shows the consequences for the side rails, noting, “the stretching produces scalloped edges on the strap 22, with the side rails 22s-1 and 22s-2 being reduced in diameter between adjoining rungs 22r.” Such scalloping is also shown in U.S. Pat. No. 4,003,106 (Schumacher, 1977, FIG. 4). It is presumably to counteract scalloping that U.S. Pat. No. 4,473,524 (Paradis, 1984, C03-L32) teaches the use of oversized side rails that are drawn down to the same thickness as the teeth.

Notwithstanding the side rail deformation, U.S. Pat. No. 4,136,148 (Joyce) teaches that the lower portion of the rungs can contain a locking abutment to engage with the tang in the head. U.S. Pat. No. 4,136,148 FIGS. 2B and 3B show the ideal stretched and unstretched (as-moulded) profile of these abutments. Since most of the stretching is confined to the side rails, these abutment surfaces are not expect to smear as much, hence the preservation of the sharp lower corner 22-r2. This is consistent with the teachings of U.S. Pat. No. 4,003,106 (Schumacher, 1977, C03-L57), which notes that “Since those components of strap 24 having smaller cross-sections will stretch before components having greater cross-sections, the stretching can be controlled and substantially limited to the portions of the side rails 30 between the rungs.”

U.S. Pat. No. 4,473,524 (Paradis, 1984, C03-L23) further adapts the transverse rungs into a fuller tooth shape on both top and bottom surfaces of the strap, their ultimate profile being controlled by the stretching process. Paradis affirms, “the teeth of the strap have a curved trailing edge which is desirably produced by stretching a trailing edge that is substantially at a right angle with respect to the principal axis of the strap.” Specifically, Paradis states the (as-moulded, preform) teeth comprise a 45 degree leading edge, a 90 degree (vertical) trailing edge, and a flat upper edge that is ⅓ of the tooth depth (ibid. C05-L48). The tooth profile after stretching is rounded (ibid. C05-L66, and FIGS. 4 and 5), and Claim 1 specifies using a generally trapezoidal tooth wherein stretching alters the tooth configuration with respect to each of the leading edge, the trailing edge, and the intermediate portion (ibid. C08-L04).

Although the prior art discuss various problems caused by stretch-orienting tie strips, there is little discussion of the preliminary injection moulding process used to produce the preforms. As much of the prior art was developed by the Dennison Manufacturing Company and the Panduit Corporation, it can be assumed that conventional moulding techniques were anticipated. As such, no explanation is necessary. The industry-standard technique is to feed molten material into a tie strip cavity through a single gate located at the head end. This is the process favoured by all major tie strip manufacturers as it ensures a consistent linear flow of material along the strip with no discontinuities. This affords some degree of molecular orientation and maximises the tensile strength of the as-moulded tie. As shown in GB2578324 (Harsley, 2020, FIG. 1) multiple tie strips are usually moulded together, either employing a hot runner system to feed each cavity independently, or more commonly, via a simple cold runner that is removed during or following part extraction. A typical configuration for standard 300 mm polyamide 6/6 cable ties would be a 16-cavity mould, with 8 ties on each side of a central cold runner, running on a machine of around 300 tonne clamping force, and cycling in around 15-20 seconds.

As will be readily appreciated, such head-gating requires the injected material to flow the whole length of the strap, hence very long or very narrow ties are harder to mould. Effectively, this limits how many cavities can be implemented on a moulding machine of a given capacity, and a significant number of prior art patents comment on the difficulties of moulding tie strips, especially those of the open-aperture ladder style. Along with various design modifications discussed by the prior art, certain process changes are also suggested. The use of higher temperatures to increase the flow (by lowering melt viscosity) is common practice, as is heating the mould to improve filling. This, however, increases the cycle time because parts cannot be extracted until they have fully frozen. Detrimentally, longer cycle times promote thermal degradation, especially at elevated melt temperatures; hence, tie strips are generally moulded on sufficiently large machines to avoid such compromises.

An alternative technique of using a central gate (c.f. U.S. Pat. No. 8,709,568, Harsley, FIG. 2) would, in principle, halve the flow length and significantly reduce injection pressure. However, in the case of ties strips, such gating leaves an undesirable weak spot due to flow divergence. This is discussed in GB2578324 (Harsley, 2020, C07-L75&c), which notes, “Such bifurcation zones often have generally anisotropic morphology and unpredictable physical properties. They are particularly problematic along the sidewalls”. The use of two or mores gates is even less desirable as it introduces regions of flow convergences, commonly known as weld lines (also referred to as (k)nit lines or cold shuts in the prior art). GB2578324 (Harsley, 2020, C08-L16 and FIG. 40) notes that multiple feed points can be used to lower pressures, but they “also create more bifurcation zones 56. Additionally, weld- and meld-lines occur where the multiple flow fronts meet 59, and these may also introduce weak spots in the resulting tie strips.” Harsley then teaches that gates should be located to avoid weld-lines on the side rails: “This horizontal configuration serves to alleviate the sidewall weld-line issues . . . the weld-lines instead being generally formed at the centres of the rungs. Such central weld-lines are often inherent in the manufacture of cellular [ladder-style] tie strips, and these are usually compensated for by making the rungs more robust along their centreline. In this respect, rung weld-lines are less problematic than weld-lines occurring along the sidewalls of the tie strips.” (ibid. C08-L78&c.) The main teachings of U.S. Pat. No. 8,709,568 (Harsley, 2014) and GB2578324 (Harsley, 2020) are to utilise multiple gates to laterally fill conjoined sheets of apertured ladder-style tie strips.

This technique inevitably results in numerous flow discontinuities, however these tie strips (commercially available under the brand name “RAPSTRAP”) are generally manufactured from polyurethane, a material that exhibits good self-bonding properties. Accordingly, bifurcation points and weld-lines do not present a significant problem. Unfortunately, this is not the case when other materials are used, especially polyamides, polyolefins and polyesters. In these materials, tie strips must be moulded longitudinally as individual components to mitigate issues with flow discontinuity.

In addition to the above physical issues, it can also be noted that the overall concept of a stretch-oriented tie strip is often counter-productive. Whilst the moulding of preforms is generally quicker and easier than the moulding of full-length ties, this benefit is offset by the additional heating and stretching stages then required. Indeed, the price of standard nylon ratchet cable ties has traditionally been so low, that any process change demands benefits that justify the increase in complexity and cost. Although stretch-orientation is known to reduce material usage by about ⅓, this in itself has not proven sufficient for mass-adoption. Furthermore, stretch-oriented tie strips are often inferior in performance to fully mould versions, and their use has thus far been limited to light duty and niche applications.

### SUMMARY OF THE PRESENT INVENTION

The present invention overcomes the aforementioned issues by employing multiple gating points along the moulded perform that deliberately introduce flow discontinuities. By doing so, each gate feeds only a relatively small amount of material into the mould cavity, thereby dramatically reducing process temperature and pressure requirements.

With a large process window available, complex geometry can be moulded more easily, including geometry that constrains the subsequent stretch-orientation to highly localised regions. When said flow discontinuities reside in such regions, they can be stretched to reorient their polymer molecules and thereby eliminated.

Furthermore, by using such geometry to constrain the stretch-orientation to diagonal bands, rows of latching teeth portions can be moved by stretching into alignment with similar nearby rows of teeth portions, such alignment resulting in the formation of transverse ratchet teeth wherein the resulting tooth pitch is substantially the same as was formed on the original perform itself.

### DESCRIPTION OF THE DRAWINGS

Reference will now be made to the accompanying diagrams and drawings in which:

FIG. 1 shows an integrally-formed ratchet tie strip

FIG. 2 shows a ladder-tie strip with webs and a latching head

FIG. 3 shows an un-webbed self-latching ladder tie with an extension filament

FIG. 4 shows a beaded tie strip with an extension filament

FIG. 5 shows weld lines in a ladder tie strip with end gates

FIG. 6 shows weld lines in a ladder tie strip with ad hoc gates

FIG. 7 shows inter-rung weld lines along the side rails of a ladder tie

FIG. 8 shows symmetrical weld lines with gates separated by an even number of rungs

FIG. 9 shows asymmetrical weld lines with gates separated by an odd number of rungs

FIG. 10 shows rung-to-rail polymer flow lines with disoriented convergent flow at the weld lines

FIG. 11 shows rung-to-rail polymer flow lines after stretch-orientation of weld lines

FIG. 12 shows stretching a low aspect-ratio cross-section

FIG. 13 shows stretching a high aspect-ratio cross-section

FIG. 14 shows short inter-rung side rail portions

FIG. 15 shows a plan view of constraining shoulders forming a non-uniform side rail

FIG. 16 shows a side view of constraining shoulders forming a non-uniform side rail

FIG. 17 shows a plan view of constraining shoulders forming latches

FIG. 18 shows a side view of constraining shoulders forming latches

FIG. 19 shows smoothed constraining shoulders after stretching

FIG. 20 shows rows of diagonal teeth portions of a preform tie strip

FIG. 21 shows a plan view of rows of diagonal teeth portions of a preform tie strip

FIG. 22 shows rows of chevron teeth portions of a preform tie strip

FIG. 23 shows a plan view of rows of chevron teeth portions of a preform tie strip

FIG. 24 shows a plan view of gating and weld line locations of rows of chevron teeth

FIG. 25 shows a plan view of stretch-sheared rows of diagonal teeth

FIG. 26 shows a side view of stretch-aligned teeth in a top-bottom staggered arrangement

FIG. 27 shows a side view of a stretch-aligned tie strip in a latching configuration

FIG. 28 shows a gated portion of stretched and unstretched ladder tie strip

### DESCRIPTION OF THE PRESENT INVENTION

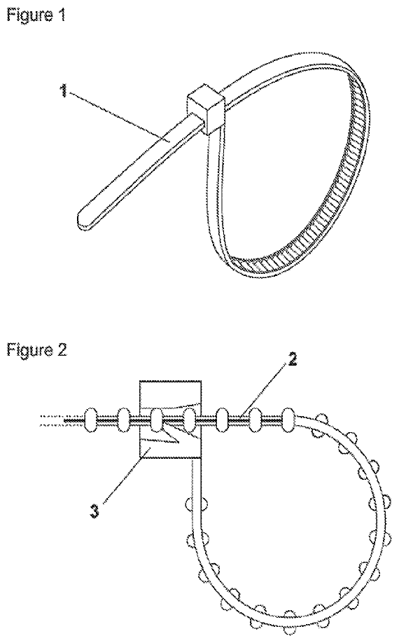

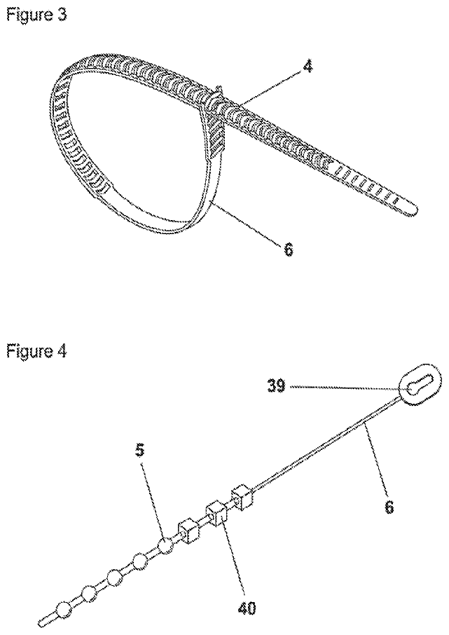

The present invention may be conveniently formed as a single part injection moulded component, preferably as a conventional ratchet tie 1 (FIG. 1) or as a ladder-style tie. Such ladder tie may be of the single-use variety with inter-rung webbing 2 and a dedicated latching head portion 3 (FIG. 2, c.f. U.S. Pat. No. 4,136,148, Joyce), or it may be a multiply-apertured self-latching ladder tie 4 (FIG. 3, c.f. U.S. Ser. No. 10/407,226, Harsley). The invention can also be adapted to produce other types of tie strip as required, such as a simple beaded tie 5 (FIG. 4). Any of these tie strips may include one or more plain filament portions 6 that increase the length of the strip without requiring extra rungs or latches.

The material of construction is a suitable stretch-orientable thermoplastic, such as PA (poly-amide), PP (poly-propylene), PE (poly-ethylene), aromatic polyesters such as PET (poly-ethylene terephthalate) or PBT (poly-butylene terephthalate), and aliphatic polyesters such as PLA (poly-lactic acid), PHB (poly-hydroxybutanoate) or PCL (poly-caprolactone). Typically, the nylons (PA) are used for manufacturing conventional cable ties, although PP tie strips are not uncommon. Under certain environmental conditions, the aliphatic polyesters are known to be biodegradable, however they tend to be weaker than conventional polymers, difficult to process, and more expensive to produce. To date, very few commercially available tie strips have been made using these polymers.

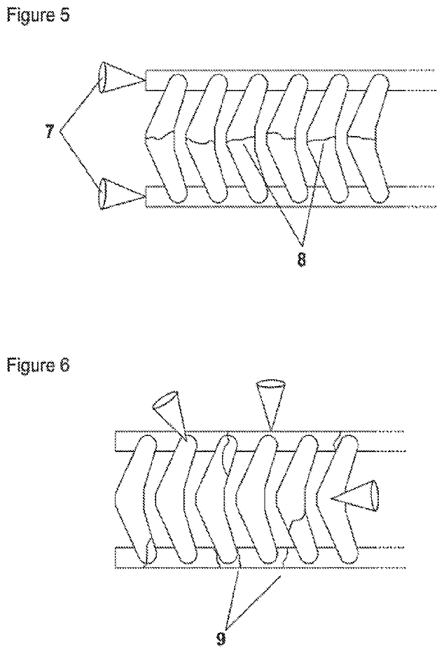

As frequently noted in the prior art, ladder-style tie strips are generally harder to mould than ratchet-style ties, especially when the gates 7 are at just one end. This, however, is essential if the resulting weld-lines 8 are to be confined to the centres of the rungs (FIG. 5), as taught by GB2578324 (Harsley, 2020, C08-L78&c). Alternative gating techniques will inevitably introduce some weld-lines 9 along the side rails (FIG. 6), and in many materials, the loss of strength caused by such defects is unacceptable.

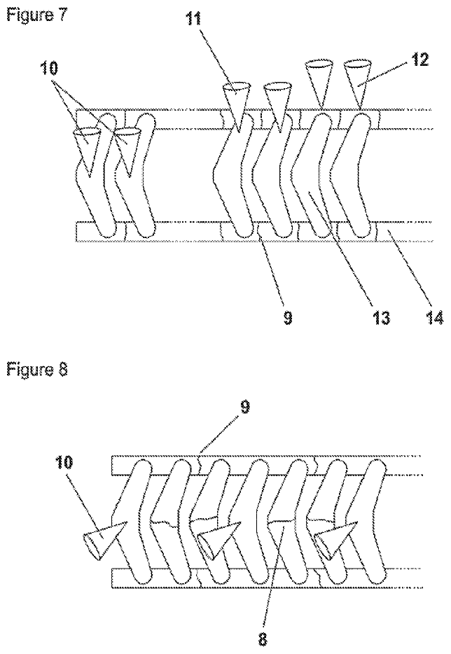

In a primary embodiment of the present invention, contrary to the prior art teachings, ladder tie strips may be injection moulded using multiple gates that are deliberately located to position the ensuing weld-lines 9 along the side rails 14 (FIG. 7). In the interests of symmetry and balanced filling of the mould, the multiple gates 10 are preferably located at the centres of the rungs, but similar gates 11, 12 may be located elsewhere on the rungs 13 or on the side rails 14 as is convenient. In all cases shown, the symmetry of the arrangement generally ensures the weld lines 9 are formed in the inter-rung region.

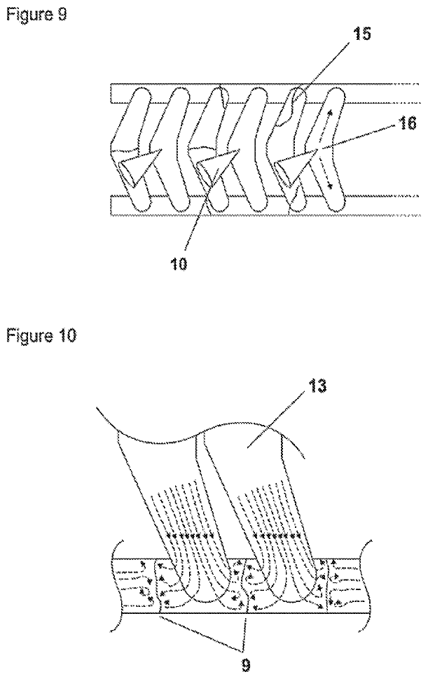

Preferably, all weld-lines 9 resulting from convergent flow should be positioned in this inter-rung region of the side rails, and when it is not possible to gate every single rung (FIG. 8), the gates 10 should be positioned such that any additional weld-lines form in the centres of the rungs 8, as is consistent with teachings of the prior art. As seen in FIG. 9, placing gates 10 one rung apart does not satisfy the primary condition as weld-lines can form around the roots of the rungs 15 rather than neatly between them. However, placing gates two rungs apart (FIG. 8) does achieve the intended result. In general, the multiple gates should preferably be located with either zero or an even number of ungated rungs between them.

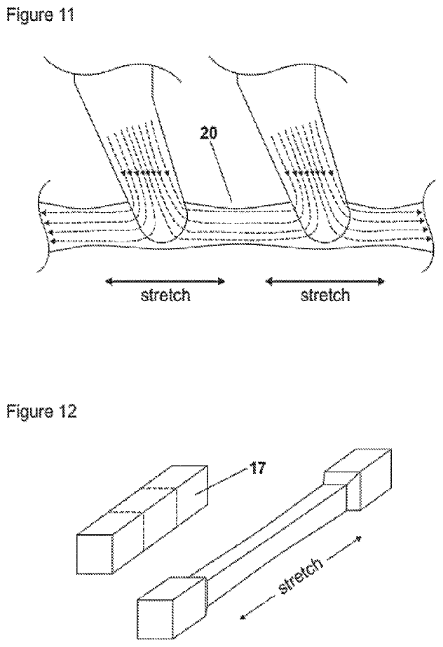

Even though the inter-rung intervals are usually the weakest part of the side rail, forming weld-lines within them is a viable approach because stretch-orientation realigns the underlying molecular structure of the polymer. Hence, if flow discontinuities (whether divergent gating points 16, or convergent weld-lines 9) are situated in regions that subsequently undergo significant stretch-orientation (FIG. 10), then said discontinuities can be substantially realigned (FIG. 11). In this way, any number of side rail defects can be eliminated resulting in maximally strong tie strips. This technique is particularly useful when weak materials are used, such as the biodegradable polymers mentioned above. Of particular interest is polycaprolactone (PCL), which melts at around 60 C and is known to biodegrade at ambient temperatures in both terrestrial and marine environments. Conveniently, stretch-orientation of this material can be done at temperatures of around 45 C, which is easily achieved by immersing the preforms in warm water. Once maximally stretched, this material is significantly stronger than in its as-moulded state, and satisfactory PCL tie strips have been manufactured according to the teachings disclosed herein.

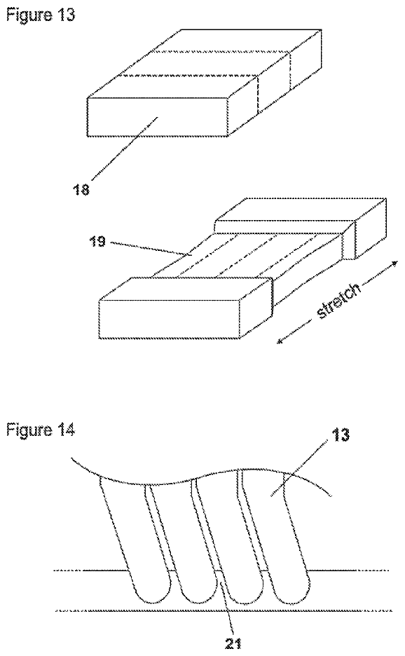

Depending on the cross-sectional profile, complete stretching of injection moulded PCL samples (and other stretch-orientable materials) typically results in an extension to 3-5 times the original length. Substantially square 17 or round cross-sections (FIG. 12) are found to extend the most and larger aspect ratio cross-sections 18 are found to extend the least (FIG. 13). Those with ratios above 6:1 are found to stretch to only around 3 times their original length. Such reduced extension is due to the constraining effect cause by neighbouring material. For instance, when a 1:1 aspect ratio cross-section is stretched, it contracts on all sides and maximally extends longitudinally (FIG. 12). However, when several such cross-sections are combined (FIG. 13), this cannot happen in the middle regions (without tearing), hence, the contraction is constrained to the edges 19 and longitudinal extension is more limited. This effect is known from the prior art, and is encountered with any substantially flat bands of material such as those found on ratchet tie strips, or with the webbing used to span the apertures between the rungs of ladder ties. This technique can be used to reduce the overall extension of the tie strip, which, as discussed in the prior art, is generally beneficial because it reduces the spacing between the rungs or latching teeth. The same effect could also be achieved by incomplete stretch-orientation, however, in the present invention, extensions approaching maximal are necessary to substantially fully reorient the polymer and thereby eliminate flow discontinuities.

As mentioned above, multiple feed gates should be located such that the resulting flow discontinuities occur at the side rail portions between two adjacent rungs 13, especially the convergent weld-lines 9 (FIG. 10). Due to the generally more robust nature of the rungs, these inter-rung sections are clearly the points at which stretching will favourably occur. Since these side rail portions typically have a small aspect ratio around 1:1, they can also be expected to undergo maximal stretch orientation and extend to around 300 to 500% of their original length 20 (FIG. 11). To ensure convergent flow discontinuities end up in this region, the gates need to be separated by the same flow time (i.e., the time taken for the polymer melt flow to reach the required point), which can be discerned either by experimentation or by computerised mould-flow finite element analysis, as is common in the industry. Reducing the flow length to a minimum by employing closely spaced gates—in extremis, one sited on every rung—helps locate the weld-line to the desired location. As the flow length gets longer there is more chance that inconsistencies in the fill will affect the flow times, and thereby cause the weld-line locations to move away from the target location.

Although, ideally, the gates themselves should also be located at the inter-rung side rails 12 (FIG. 7), in practice it is easier and adequate to locate such points of flow divergence on the rungs 10. As noted in the prior art, the rungs are easier to reinforce, and gating onto them is especially convenient in designs that embody rungs that extend above the height of the side rails

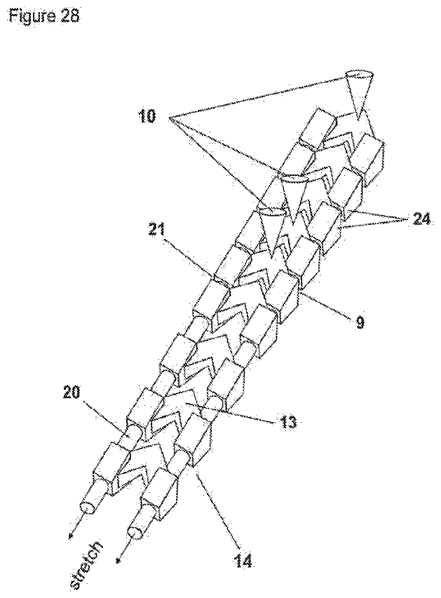

Based on prior art ladder ties of approximately 6 to 8 mm width, the aperture length between adjacent rungs 13 of the finished (post-stretching) product should be in the order of 1.5 mm. Therefore, assuming a 5-fold maximal extension, the inter-rung side rail portions 21 of the preform should be approximately 300 microns in length (FIGS. 14 and 28). However, in practice, stretching a tie strip with substantially uniform side rails actually leads to a much greater extension with the apertures typically extending to around 5 mm in length (i.e., a 15-fold extension). This is because additional material is drawn in from neighbouring regions, and this “smearing” or bleeding feeds the stretching process.

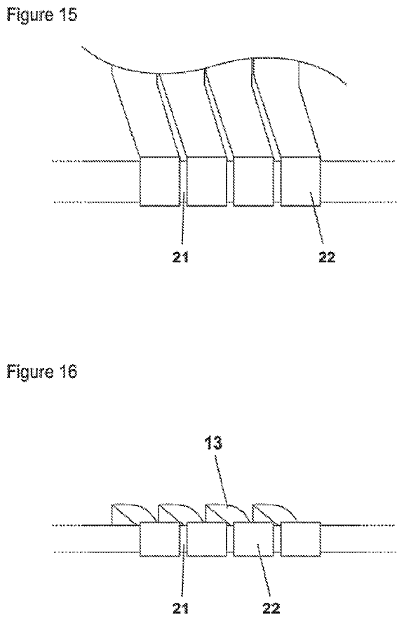

According to the present invention, it is found that such bleeding of adjacent material can be inhibited by enclosing the inter-rung section of side rail with sharp edges or shoulders 22, preferably projecting outwards at approximately 90 degrees on all sides of the rail (FIGS. 15 and 16). For a typical 6 to 8 mm wide tie strip with approximately 1.5 mm thick side rails, these shoulders should extend at least 200 to 300 microns outwards of the region to be stretched, and preferably at least 400 to 600 microns. Shoulders extending from all sides are found to be superior, and very short inter-rung segments around 200 to 300 microns in length have been limited to a maximum stretch of about 1.5 mm using this technique. In other words, non-uniform side rails are necessary to prevent excessive bleeding of adjacent material during the stretching process. To achieve this, the constraining shoulders are preferably placed at both ends of the inter-rung section to be stretched, and project sufficiently perpendicularly that material cannot be substantially drawn longitudinally from it. This is in contrast to a simple reduction in the cross-sectional thickness as mentioned in the prior art. Although such reduction can indeed be used to favour stretching of the narrowed region, it does not prevent the smearing of material from neighbouring regions.

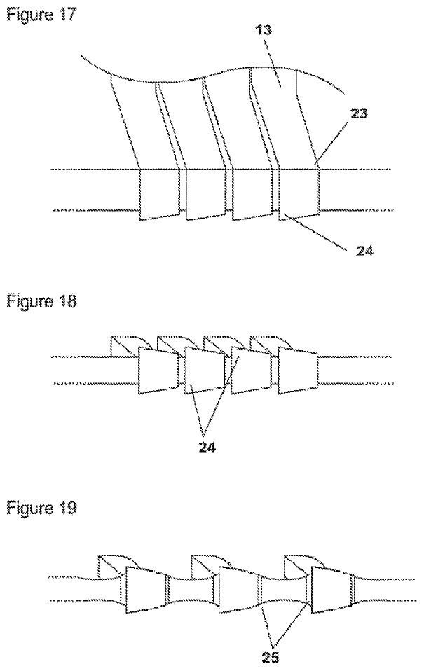

Necessarily, the inside edges 23 of the shoulders already extend inward due to being the root of the transverse rung portion 13, and the top and outside edges can be advantageously adapted to form latching barbs 24 (FIGS. 17 and 18). The underside of the side rail is of no consequence during threading, since it does not generally run against any other surface. Therefore, the addition of such shoulders or latches on all four sides of the side rail is not too problematic. However, it is not completely without consequence, as the side rail edges are no longer smooth and continuous (FIG. 19). This makes threading the tie strips prone to snagging especially if larger shoulders are used to better reduce smearing. In practice, a small amount of smearing 25—as encountered with smaller shoulders—is found to be favourable. The resulting smoothing also helps strengthen the flow discontinuities as it brings in material from a wider area and allows for some slight variation in the location of the flow discontinuity.

In the absence of inter-rung webbing, there is no significant deformation or smearing of the rung centres, hence if these portions are also used for latching purposes (as known from U.S. Ser. No. 10/407,226, (Harsley, 2019)), then the reduced latching integrity caused by smoothing the shoulder latches does not significantly reduce performance. In addition, it is found that slightly smoothed shoulder latches can allow the latch to be undone without damaging it, thereby providing for a releasable and reusable tie strip, as shown by US2013014350 (Lie, 2013, FIG. 5).

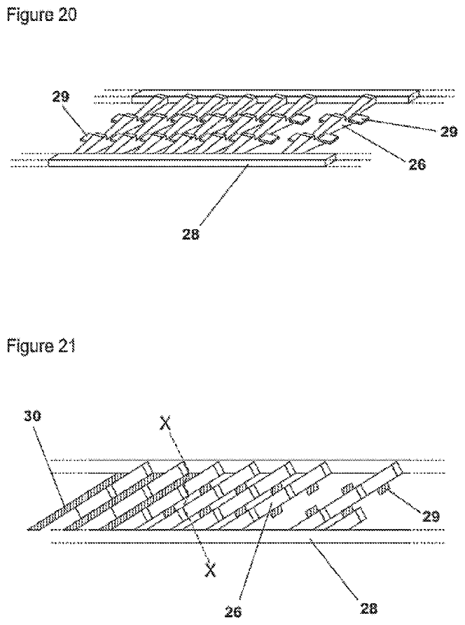

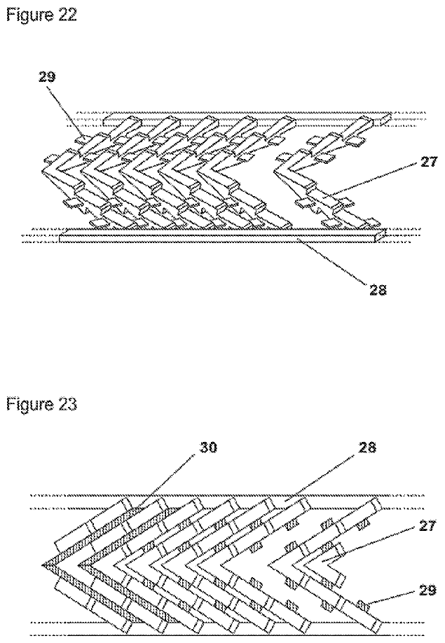

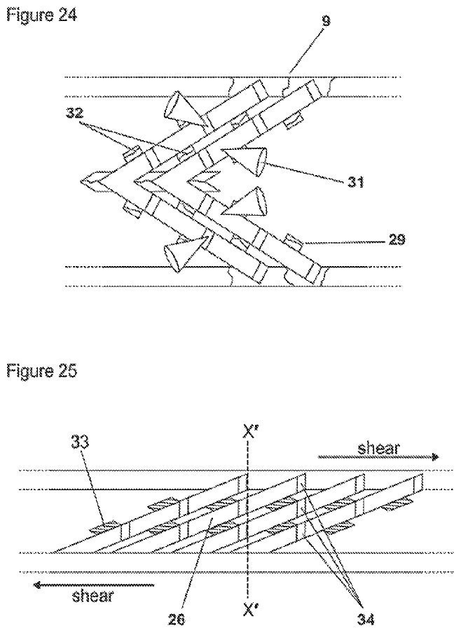

The technique described above of using multiple gates to position flow discontinuities between constraining shoulders can also be used to produce conventional ratchet style tie strips. As noted by the prior art, a significant issue with stretch-orienting ratchet tie strips is the resulting increase in tooth pitch, which leads to poor fineness of control over the tied loop diameter. The present invention can be used to solve this problem if projecting teeth portions are arranged in diagonal rows 26 either extending across the strip (FIGS. 20 and 21), or extending symmetrically from the longitudinal centreline of the strip so as to form a chevron arrangement 27 (FIGS. 22 and 23). Such a strip may also have side rails 28, but this is not essential.

Residing between these rows of teeth portions are thin interconnecting portions, which may be formed as small segments 29 or thin continuous bands 30 between adjacent rows of teeth (FIGS. 21 and 23). Consistent with the required post-stretching strength requirements, these inter-tooth connecting portions are preferably made as short and as thin as possible, typically being 0.5 to 1 mm in height and width. In effect, they serve the same purpose as the interconnecting rung portions 21 of the ladder-style embodiment described above (FIG. 15). Although a large plurality of such small interconnecting portions 29 would be difficult to mould by conventional approaches, the use of multiple gates 31 allows easy production of such geometry (FIG. 24). When suitably located, these gates result in symmetric flow times such that the resulting weld lines are located in the side rail 9 and in the inter-tooth connecting portions 32 (FIG. 24). As described above, these regions are later subjected to stretch-orientation to realign the disordered molecular structure, and due to the vertical projection of the teeth portions, the thin interconnecting portions are essentially constrained by a similar shouldering arrangement as previously disclosed. Hence, very little material will bleed from the teeth themselves during stretching, thereby preserving the sharp edges of the latching teeth portions.

Because the interconnecting portions are significantly thinner and smaller than the teeth portions, when subjected to longitudinal stretching, they substantially deform 33 whereas the teeth portions 26 do not. Being more robust, the rows of teeth portions shearingly move longitudinally in their respective groups into a displaced position (FIG. 25, c.f. FIG. 21). If the resulting displaced positions are such that adjacent rows of teeth are correctly aligned, then substantially transverse ratchet teeth 34 are formed across the strip. Such an alignment is depicted as section X′-X′ in FIG. 25 (c.f. section X-X in FIG. 21). Importantly, because the rows of teeth portions 26 have not themselves significantly deformed, the distance between the resulting ratchet teeth is substantially the same as the tooth pitch of the original moulded preform tie strips. In this way, the desirable close tooth pitch of a standard moulded ratchet-toothed tie strip is maintained.

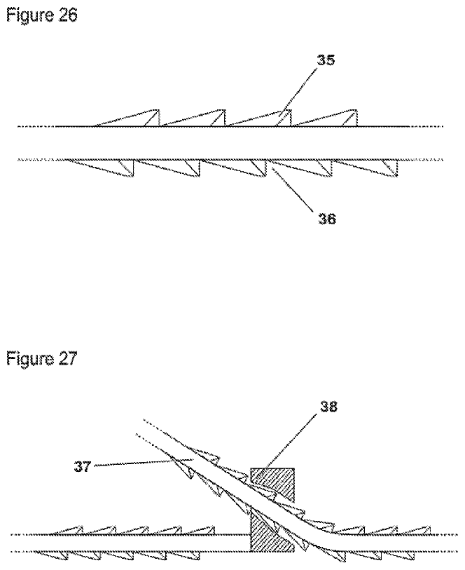

Although rows teeth portions can be formed on just one side of the strap, advantageously rows of teeth are formed into both upper and lower surfaces (FIG. 26). To avoid the creation of weak points, the teeth may be offset such that the crest of a tooth on the upper side 35 substantially overlaps the root of a tooth on the lower side 36. The overall cross-section is therefore made more consistent. Once the tie has been formed into a loop, this configuration is also beneficial in forming a more secure latch, since the extension of the strip beyond the latch 37 tends to reside at an angle (FIG. 27). By exploiting this angle on the latching surfaces of the head portion, the staggered teeth naturally latch on both upper and lower edges of the receiving apertured head 38. The withdrawal force needed to cause failure of the latch is therefore increased.

It is found that rows of teeth set at angles of less than 30 degrees to the longitudinal axis are favourable; Very shallow angles can result in small longitudinal displacement upon stretching, and very large angles result in too much. Because the longitudinal displacement of the teeth may not be uniform across the width of the strap, the angle of the teeth on the preform can be adjusted along the row to compensate as required. For similar reasons, the teeth portions moulded into the preform may also be arranged in a staggered pattern to allow for such non-uniform transport during stretching.

Although the stretching phase of the present invention can be affected by any suitable means, stretching the preforms between pairs of rollers (as taught by U.S. Pat. No. 3,237,255 (Stanton, 1966)) affords the most control over the process. This technique is most suitable for self-latching ladder ties, since there is no upstanding head portion. Where other types of tie strip are to be stretched, either a design utilising a low-profile head portion is required (such as illustrated by the bead tie of FIG. 4), or alternatively, the rollers can be made to open and close at appropriate points to allow passage of the head portion. When combined with independent control of roller speed, such a device is versatile enough to stretch ties by any predetermined amount along any portion of the strip. In this way, extension filaments 6 can be introduced towards the head portion of the tie strip such that latches are only required at the re-entrant end (FIG. 3). Thus, a tie designed for a particular size of application does not need to implement latches along the whole length, as taught by U.S. Pat. No. 6,105,210 (Benoit, 1999). Because they do not form a latchingly functional aspect of the tie, these extension filaments can be stretched more than the latching portion of the tie strip, and so facilitate easier and cheaper production of longer tie strips.

As well as being suitable for making ladder-style ties (with or without webbing between the rungs) and for making ratchet-style ties, the techniques disclosed above may also be employed for making other forms of tie strips, such as bead-style ties (FIG. 4), as commonly used for security seals. It can be noted that such bead ties essentially comprise a single side-rail of a ladder-style tie with an appropriate remote head portion. For releasable ties, the aperture enclosed by the head portion is often formed as a keyhole slot 39. Advantageously for the present invention, the beads may be substantially formed as cubical segments 40 appropriately positioned along the preform, such that subsequent stretching is constrained to the inter-bead segments due to the perpendicular sides acting as shoulders as described above.

### DESCRIPTION OF A FIRST PREFERRED EMBODIMENT

A ladder-style tie strip (FIG. 28) fabricated from a stretch-orientable material, comprising a plurality of substantially transverse rung portions 13 residing between a pair of longitudinal side rail portions 14, wherein a re-entrant end portion of the stretched strip can latchingly pass through an aperture formed between adjacent rungs and thereby form a closed loop.

The strip is preformed in a contracted state by a process of injection moulding that utilises multiple gates 10 along the strip, each gate feeding into the centre of a rung portion wherein each gated rung portion is separated by zero or an even number of other rung portions. The gates being so located such that points of convergent melt flow 9 (i.e., weld lines) occur within short inter-rung sections of the side rails 21.

By stretching the preformed strip, the disorganised molecular structure of the weld lines is reoriented into a substantially longitudinal arrangement. Shoulders 24 outwardly projecting on all sides of the side rail are located at either end of the short inter-rung side rail portions, and serve to constrain maximal stretching to these regions. Accordingly, the short inter-rung portions containing the weld lines extend to between 300 and 500% of their original length 20, whereas the overall tie strip extends by only 50 to 150%.

### DESCRIPTION OF A SECOND PREFERRED EMBODIMENT

A tie strip fabricated from a stretch-orientable material, comprising at one end a ladder-style plurality of substantially transverse rung portions residing between a pair of longitudinal side rails, and at the opposite end an apertured head portion for receiving the ladder portion to form a securely closed loop. For ease of manufacture, the inter-rung portions may be webbed over, and the ladder portion and head portion may be separated by a plain band or filament portion.

The strip is preformed in a contracted state by a process of injection moulding that utilises multiple gates along the strip, each gate feeding into the centre of a rung portion wherein each gated rung portion is separated by zero or an even number of other rung portions. The gates being so located such that weld lines occur within short inter-rung sections of the side rails.

By stretching the preformed strip, the disorganised molecular structure of the weld lines is reoriented into a substantially longitudinal arrangement. Shoulders outwardly projecting on all sides of the side rail are located at either end of short inter-rung side rail portions and serve to constrain maximal stretching to these regions. Accordingly, the short inter-rung portions containing the weld lines extend to between 300 and 500% of their original length, whereas the overall ladder portion of the tie strip extends by only 50 to 150%.

For conveniently extending the length of the tie strip where required, the plain band or filament portion is maximally stretched to between 300 and 500% of its original length.

### DESCRIPTION OF A THIRD PREFERRED EMBODIMENT

A ratchet-toothed style tie strip fabricated from a stretch-orientable material, comprising an apertured head portion at a distal end and a tail portion extending thereof, said tail portion possessing a plurality of narrow rows of vertically projecting teeth arranged in a diagonal or chevron pattern on one or both sides of the strip, the rows being separated by short interconnecting portions.

The strip is preformed in a contracted state by a process of injection moulding that utilises multiple gates along the strip, each gate being located along a row of teeth such that weld lines occur within the inter-row interconnecting portions. Subsequent stretching of the tail portion occurs preferentially along these diagonal interconnecting portions and removes the weld lines by molecular reorientation.

The rows of teeth are made sufficiently robust to avoid being substantially stretched. The stretching process instead causes adjacent rows of teeth to slide past each other and move into a new longitudinal arrangement, whereby a substantially lateral alignment is achieved such that the individual teeth along adjacent rows form lateral ratchet latches for engaging with the apertured head portion to form a secure closed loop.

These so-formed lateral ratchet latches retain substantially the same close pitch as the preform teeth. Said teeth being also made tall enough to act as constraining shoulders to ensure stretching is limited to the thin interconnecting portions and reduce smearing of adjacent regions.

### DESCRIPTION OF A FOURTH PREFERRED EMBODIMENT

A bead-style tie strip fabricated from a stretch-orientable material, comprising an apertured head portion at a distal end and a tail portion extending thereof, said tail portion comprising a row of substantially spherical or cubical beads separated by short, thinner filament portions.

The strip is preformed in a contracted state by a process of injection moulding that utilises multiple gates along the strip. Each gate feeds into the centre of a bead portion and each gated bead portion is separated by zero or an even number of other bead portions, the gates being so located such that weld lines are located along the filament portions between adjacent bead portions.

By stretching the preform strip, the disorganised molecular structure of the weld lines is reoriented into a substantially longitudinal arrangement. The beads serve as projecting shoulders at either end of the short inter-bead filament portions that contain the weld lines, and thereby constrain maximal stretching to the inter-bead region such that the short inter-bead filament portions are extended to between 300 and 500% of their original size, whereas the overall tie strip extends by only 50 to 150%.

1. A method of making a tie strip from as stretch-orientable thermoplastic comprising a series of joined unit cells, wherein the molding material is injected into the mold at multiple gating points along the strip to introduce flow discontinuities thereby to localize regions for stretch orientation.

2. A method according to claim 1, wherein the tie strip is a ladder-style tie strip comprising a plurality of substantially transverse rung portions residing between a pair of longitudinally extending side rail portions, and wherein the method includes the use of multiple gates along the strip, each gate feeding into the center of a rung portion, and wherein each gated rung portion is separated by zero or an even number of rung portions.

3. A method according to claim 2, wherein the tie is molded to form edges or shoulders at the inter-rung sections of the side rails.

4. A method according to claim 3, wherein the edges or shoulders project outwards at approximately 90 degrees on sides of each rail.

5. A method according to claim 4, wherein the tie is molded to form constraining shoulders located at either end of the inter-rung section to be stretched.

6. A method according to claim 2, wherein the tie is molded to form projected teeth portions arranged in diagonal rows extending either across the strip or extending symmetrically from a longitudinal centerline of the strip to form a chevron arrangement.

7. A method according to claim 1, wherein the tie strip is a ratchet-toothed style tie strip comprising an apertured head portion at a distal end and a tail portion extending therefrom, said tail portion including a plurality rows of vertically projecting teeth arranged in a diagonal or chevron pattern on one or both sides of the strip, and wherein the method includes the use of multiple gates along a row of teeth such that weld lines occur within the inter-row connecting portions.

8. A method according to claim 1, wherein the tie strip is a bead style tie strip comprising an apertured head portion at a distal end and a tail portion extending therefrom, said tail portion comprising a row of substantially spherical or cubical beads separated by filament portions, and wherein the method includes the use of multiple gates along the strip, each gate feeding the molding material into the center of the bead portion and each gate beaded portion is located such that weld lines are formed along the filament portions between adjacent bead portions.

9. A method according to claim 1, wherein the molding material is polycaprolactone (PCL).
